(19) United States
(12) Patent Application Publication
(10) Pub. No.: US 2013/0300571 A1
(43) Pub. Date: Nov. 14, 2013

(54) INTERROGATION OF ACTIVE AND PASSIVE PROPPANTS FOR REAL-TIME MONITORING OF FRACTURED WELLS

(71) Applicant: Farrokh Mohamadi, Newport Beach, CA (US)

(72) Inventor: Farrokh Mohamadi, Newport Beach, CA (US)

(21) Appl. No.: 13/865,864

(22) Filed: Apr. 18, 2013

Related U.S. Application Data
(60) Provisional application No. 61/635,064, filed on Apr. 18, 2012.
(60) Provisional application No. 61/636,983, filed on Apr. 23, 2012.

(51) Int. Cl. G01V 3/30; G06K 19/077

(52) U.S. Cl. CPC G01V 3/30; G06K 19/07749
USPC 340/854.6; 235/492

(57) ABSTRACT

A variety of resonant tags are disclosed that are sized to be approximately the same size as proppants. The resonant tags have a resonant frequency that changes in response to pressure and temperature changes.

### RELATED APPLICATION

This application claims the benefit of U.S. Provisional Application No. 61/635,064, filed Apr. 18, 2012. In addition, this application claims the benefit of U.S. Provisional Application No. 61/638,983, filed Apr. 26, 2012.

### TECHNICAL FIELD

The present disclosure relates to proppants, and more particularly to a real-time monitoring system of fractured wells using active and passive proppants.

### BACKGROUND

The use of proppants in conjunction with the hydraulic fracturing of shale and other “tight oil” formations has resulted in remarkable petroleum recoveries in the U.S. For example, the annual oil production in North Dakota now exceeds the production from Alaska—a remarkable development all buttressed on the use of proppants to “prop” open the hydraulically-created fractures in the oil-bearing rock. As a result, the proppant market in the U.S. is now in the billions of dollars per year and growing.

The recovery of tight oil through the use of proppants could easily make the U.S. self-sufficient in or even a net exporter of petroleum. Nevertheless, environmental concerns are hampering widespread use of hydraulic fracturing. In that regard, one can appreciate that many of these concerns are overblown in that the rock formations being fractured are typically thousands of feet deep whereas ground water supplies are far removed from such depths. Nevertheless, the growth of hydraulic fracturing techniques depends upon addressing and monitoring any escape of the hydraulic fracturing fluids from the fractured rock formation. For example, such escape is conceivable if a natural fault extends through the hydrocarbon-bearing rock formation being fractured up through the shallower depths from which ground water is extracted.

Existing electronics-based downhole gauges are unable to survive the increasingly high temperature conditions experienced in modern, deep oil and gas wells. Raman-OFDR optical-fiber-based sensors offer many advantages over existing downhole electronic gauges. However, the single string of optical fiber just covers a small area of the entire well volume. The problem becomes more serious for fractured wells in which the use of fiber-optics for in-situ monitoring of the fracking process is impossible.

There is thus a need in the art for better techniques to monitor hydraulically fractured wells

### SUMMARY

To address the aforementioned needs, a variety of resonant tags are disclosed that have resonant structures having resonant frequencies that change in response to pressure and/or temperature changes. Each resonant tag is encapsulated in resin or ceramic material sized to be approximately the same size as conventional proppants being injected into a propped fracture. The resonant tags will thus be positioned throughout a propped fracture in the same manner as the conventional proppants. In this fashion, resonant tags may be mixed with conventional proppants and hydraulically injected into a perforated well casing to hydraulically fracture a hydrocarbon bearing rock layer. The resulting fractures are propped by the conventional proppants as known in the “fracking” arts. The resonant tags may then be interrogated with an RF signal that is frequency modulated over the expected resonant frequency range induced by temperature and/or pressure differences.

The interrogator can time the delay between when an interrogating signal was transmitted and when a resulting reflected resonant transmission is received from an illuminated resonant tag. This delay provides the range to an illuminated resonant tag. In addition, the interrogator can determine the frequency of the reflected resonant transmission from the illuminated resonant tag. This frequency may be mapped to a given pressure or temperature reading. By sampling various propped fractures, an interrogator can determine a pressure or temperature profile across the propped fractures. Propped fractures with anomalous pressure or temperature readings may be used to detect potential leaks of the hydraulic fracturing fluid from the fractured rock layer. The resonant tags may be entirely passive structures or may include active circuitry.

In accordance with an embodiment, a resonant tag is provided that includes: a substrate; a beam suspended above the substrate by a pair of end walls; and material configured to encapsulate the substrate, the beam, and the end walls such that the resonant tag has a size approximating the size of a proppant.

In accordance with another embodiment, a resonant tag is provided that includes: a cylindrical array comprising a plurality of first cylinders arranged to form a second hollow cylinder; a dielectric material configured to fill the second hollow cylinder; and material configured to encapsulated the filled cylindrical array such that the resonant tag has a size approximating the size of a proppant.

In accordance with another embodiment, a method of interrogating a well is provided that includes: mixing a plurality of resonant tags with proppants to form a hydraulic fracturing fluid, wherein each resonant tag comprises a substrate, a beam suspended above the substrate by a pair of end walls, and material configured to encapsulate the substrate, the beam, and the end walls such that the resonant tag has a size approximating the size of the proppants; fracturing a rock layer surrounding the well with the hydraulic fracturing fluid to form propped fractures in the rock layer, wherein each propped fracture includes some of the resonant tags; and interrogating the resonant tags in the propped fractures with a frequency modulated interrogating RF signal, wherein each beam is configured to have a resonant frequency that changes in response to pressure changes, and wherein the frequency modulation covers an expected range of the resonant frequencies induced by the pressure changes.

This summary is provided to introduce a selection of concepts in a simplified form that are further described below. This summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

The present disclosure, both as to its organization and manner of operation, may be understood by reference to the following description, taken in connection with the accompanying drawings, in which:

FIG. 1A is a cross-sectional view of a suspended beam resonant structure for inclusion within a resonant tag.

FIG. 1B is a cross-sectional view of the suspended beam resonant structure, wherein the suspended beam is deformed due to application of pressure.

FIG. 2A is a plan view of a starting substrate for the manufacture of the suspended beam resonant structure of FIG. 1A.

FIG. 2B is a cross-sectional view of the starting substrate of FIG. 2B.

FIG. 3A is a plan view of the substrate of FIG. 2A after application and patterning of a sacrificial layer.

FIG. 3B is a cross-sectional view of the substrate of FIG. 2B after application and patterning of a sacrificial layer.

FIG. 4A is a plan view of the substrate of FIG. 3A after deposition and patterning of metallic layers used to form the suspended beam and its end walls.

FIG. 4B is a cross-sectional view of the substrate of FIG. 3B after deposition and patterning of metallic layers used to form the suspended beam and its end walls.

FIG. 5A is a plan view of the suspended beam of FIG. 4A after removal of the sacrificial layer.

FIG. 5B is a cross-sectional view of the suspended beam of FIG. 4B after removal of the sacrificial layer.

FIG. 6A is a cross-sectional view of a resonant cylindrical array structure with high Q factor.

FIG. 6B is a perspective view of the resonant cylindrical array structure with high Q factor of FIG. 6A.

FIG. 7 is a cross-sectional view of a well bore casing configured to include a plurality of integrated interrogators.

FIG. 8 is a cross-sectional view of a well bore including an actuated interrogator.

FIG. 9A is a plan view of a suspended beam array including active circuitry.

FIG. 9B is a cross-sectional view of the suspended beam array of FIG. 9A.

FIG. 9C is a cross-sectional view of the suspended beam array of FIG. 9A after application of pressure so as to deform the suspended beams.

### DETAILED DESCRIPTION

Proppants are disclosed that allow the passive or active monitoring of temperature and pressure in the propped fractures in the hydraulically fractured hydrocarbon-bearing rock formations. These “smart-proppants” may be mixed with conventional proppants and hydraulically injected into the to-be-fractured rock formations at sufficient pressures to fracture the rock as known in the hydraulic fracturing (also known as fracking) arts. Regardless of whether an active or passive embodiment is used, a user has the ability to directly monitor the conditions within the propped fractures. For example, should a given propped fracture have anomalously lower pressures as compared to neighboring propped fractures, a user may advantageously detect the existence of leaks or natural faults that could allow the proppant fluid to escape the “tight” rock formations being fractured into overlaying ground water formations. In this fashion, the environmental concerns about fracking may be addressed and monitored.

### Passive Embodiments

Resonant structures are embedded into proppant-sized enclosures and mixed with conventional proppants prior to being hydraulically injected into a borehole that have a resonant frequency that changes in response to changes in temperature and pressure. In this fashion, an interrogator may transmit an interrogating signal that is swept in frequency over the expected resonant frequency range for the resonant structures. For example, suppose the resonant frequency change maps to a change in pressure. One would expect the propped fractures to all have a relatively similar pressure profile based upon ambient pressure within the borehole. But if the pressure profile for the resonant structures in subset of the propped fractures is significantly different, a potential leak or fault line in the fractured rock may be indicated. Several different resonant structures are disclosed of what is denoted herein as a “resonant tag.”

Regardless of the topology for the particular resonant structure embodiment, the resulting structure needs to be sized so as to fit within a proppant-sized enclosure. In that regard, conventional spherical proppant particles have a diameter of around 100 μm to 2.4 mm. Thus, if a resonant structure is formed on a planar substrate, that substrate must have a linear extent to fit within a proppant-sized enclosure that has a diameter approximating the diameter of the proppant being injected into the well.

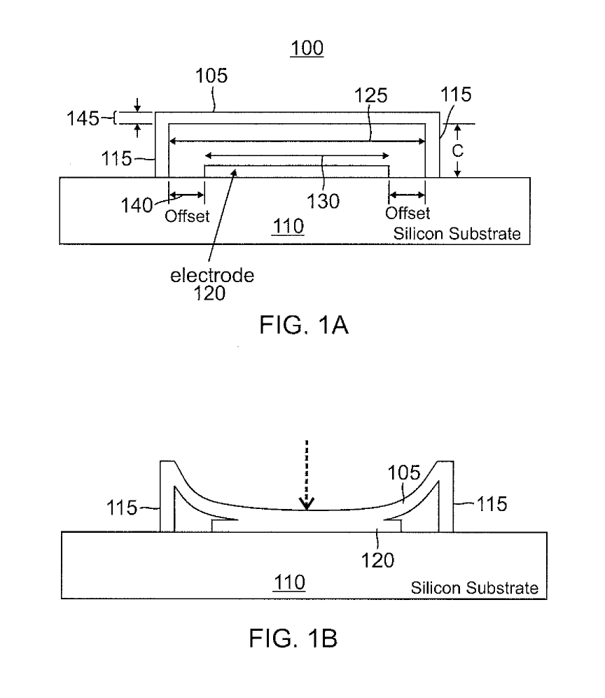

Turning now to the drawings, FIGS. 1A and 1B illustrate a first embodiment of a resonant tag comprising a deformable metal reflector 100. The reflector includes a planar beam 105 suspended above a substrate 110 by end walls 115. In response to pressure, planar structure 105 may deflect towards an opposing electrode 120 as shown in FIG. 1B. The resonant frequency for the default configuration of FIG. 1A changes in response to the deformation shown in FIG. 1B. In one embodiment, beam 105, end walls 115 and electrode 120 may comprise gold whereas substrate 110 may comprise silicon. Beam 105 has a length 125 whereas electrode 120 has a shorter length 130. The difference between lengths 125 and 130 determines an offset 140 between end walls 115 and electrode 120. Beam 105 has a thickness 145 such as 2 microns. Length 125 as opposed to a width of beam 105 determines the force necessary to deform beam so at to contact electrode 120 as shown in FIG. 1B.

As one would expect, the necessary force to cause contact between the beam and the electrode diminishes as the beam length increases. Longer beams have less stored energy and would thus be less inclined to “spring back” towards the default (not deflected) position. In that regard, the beam will be subjected to the highest pressure during the hydraulic fracking process in which the resonant tag is injected into the resulting propped fractures. The shortest possible beam length is thus favored with regard to then measuring a subsequent pressure drop due to leakage from the propped fracture. Conversely, the smaller the beam length, the higher will be its resulting resonant frequency. It is more expensive to construct a frequency sweeping interrogator at higher frequencies such as in the 200 to 300 GHz band. The change in resonant frequency from deformation is expected to be in the MHz range (e.g., 50 MHz). In contrast, it is less expensive to design a lower frequency interrogator such as a millimeter wave interrogator in the 30 to 100 GHz band to be able to sweep across a search band of 50 MHz. Thus, the resulting resonant tag design for a suspended beam embodiment represents a tradeoff between interrogator cost and spring force.

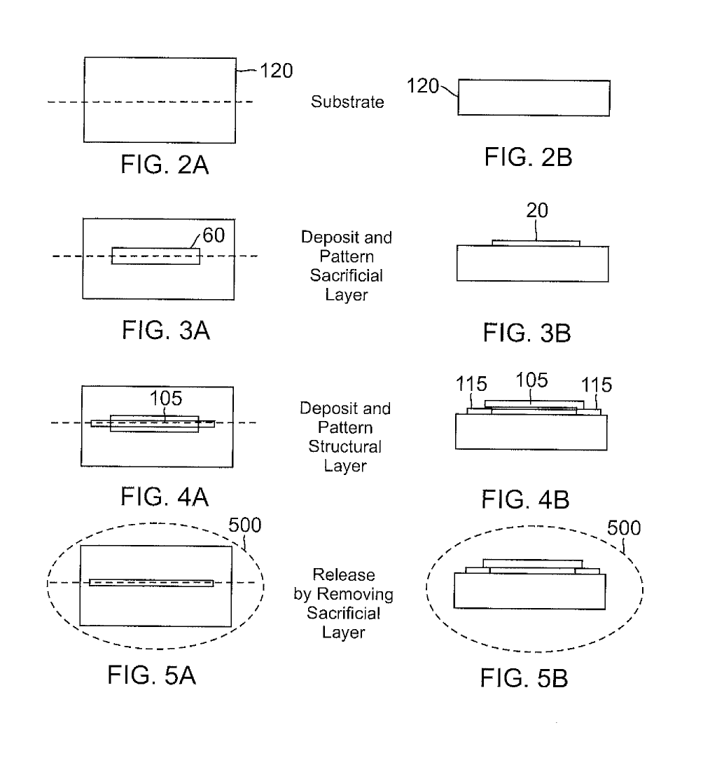

An example method of manufacture for a suspended beam resonant tag embodiment will now be discussed. The starting substrate 120 is shown in FIGS. 2A and 2B. As shown in FIGS. 23A and 3B, a sacrificial layer 300 may then be deposited and patterned on substrate 120 (for illustration clarity, the formation of electrode 120 is not shown but one or ordinary skill will appreciate that sacrificial layer 300 would overlay electrode 120). Gold or other suitable conductor may then be deposited over sacrificial layer 300 and onto substrate 120 to form end walls 115 and beam 105. To complete construction of a resonant tag 500, sacrificial layer 300 is etched away and the substrate encapsulated with a resin or composite material to form the desired “smart proppant” size as shown in FIGS. 5A and 5B.

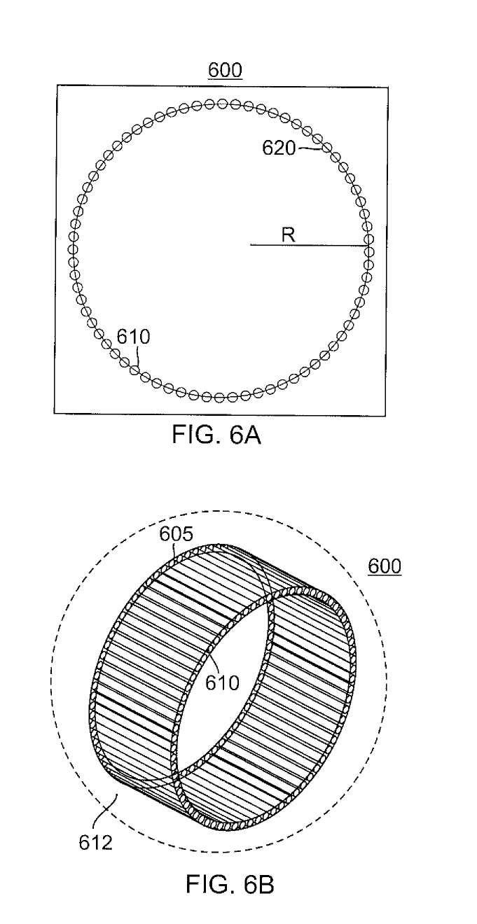

A resonant tag 600 that is particularly advantageous for measuring temperature is shown in FIGS. 6A and 6B. Resonant tag 600 includes a metallic cylindrical array 605 filled with a low dielectric material. In one embodiment, cylindrical array 605 has a radius R of 500 microns and a thickness of 2 microns. As seen in the cross-sectional view of FIG. 6A, array 605 includes a plurality of longitudinally extending cylinders or semi-cylinders 610. A cylinder 610 is darkened in the perspective view of FIG. 6B for illustration purposes. In one embodiment, each cylinder 610 may have a radius of 20 microns. Given these dimensions, cylinder array 605 is readily embedded in resin or ceramic material 615 to form resonant tag 600. Simulation results for such an embodiment indicate advantageously high Q values such as 10,000 or higher. Other highly resonant shapes may be used to achieve such high Q values. For example, cylinders 610 may instead have a pyramidal cross section instead of a circular cross-section.

As an example, an interrogator for resonant tag 600 will transmit a series of short pulses with variable length in the frequency band of 200 GHZ to 300 GHz. Scanning across this range of 100 GHz with 20 MHz bandwidth pulses results in 5000 temperature variation incremental points that may be assessed. If a crack on a well's cement casing or a propped fracture leaks to the outside environment, the temperature difference between the wellbore at 5000 ft. can start varying from the below-ground ambient temperature of (for example) 250 degrees to lower temperature. A minute variation of just 0.001 degrees can be thus detected by injecting a plurality of resonant tags with conventional proppants into a hydraulically-created fracture. For lower cost systems, the resonator material may be selected to be optimized to the desired resolution of temperature detection.

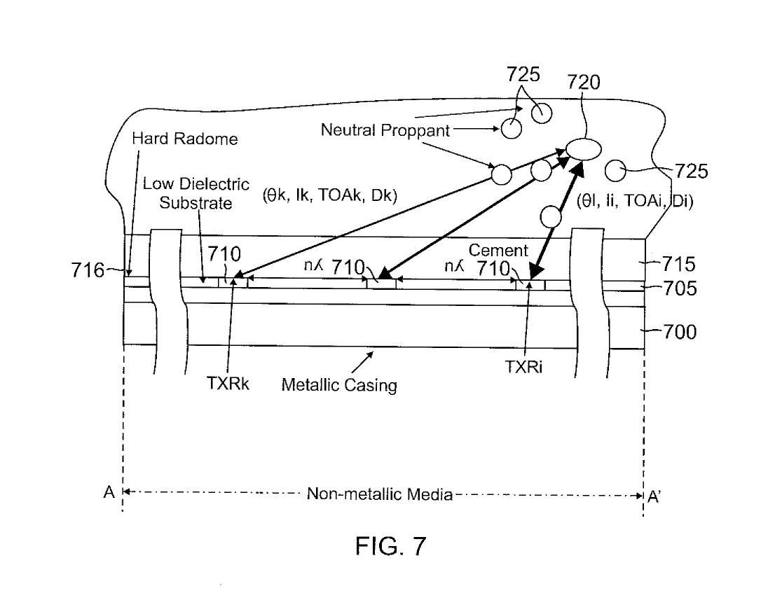

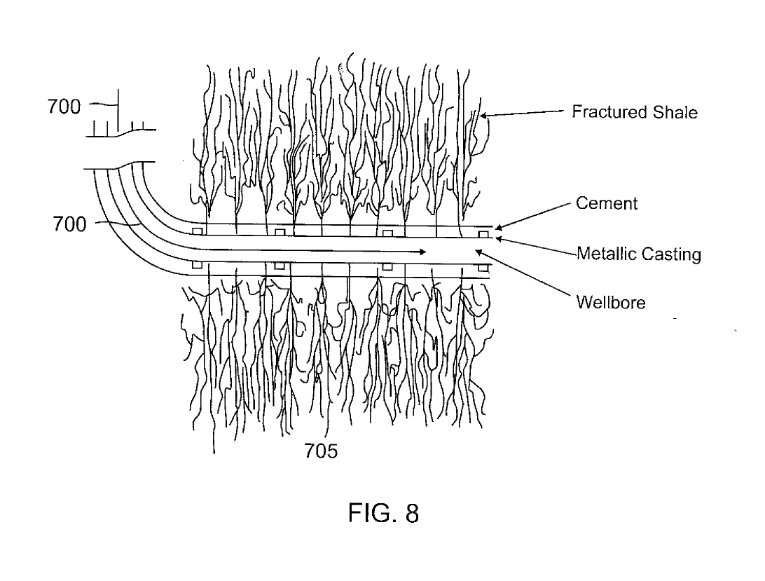

Regardless of the particular topology used to implement a resonant tag, the corresponding interrogator may be incorporated into the well casing itself as shown in FIG. 7. A metallic casing 700 in the well bore may be coated with a low dielectric substrate 705 that contains a plurality of transmitting and receiving antenna arrays 710. A radome 716 and cement casing 715 encases arrays 710 and dielectric substrate 705. A resonant tag 720 has been injected into fractures propped by conventional proppants 725.

Each array 710 acts as an interrogator that transmits RF energy towards resonant tag 720 and receives reflected energy from such a transmission. In one embodiment, arrays 710 may perform beam steering to scan through the hydrocarbon-bearing rock layer to detect resonant active tags buried therein. The number of interrogators is arbitrary such that a given interrogator may be designated as the kth interrogator. From the beam steering, the kth interrogator would know the beam steering angle θ used to illuminate a given resonant tag. The delay between transmission and receipt of the reflected RF energy provides the range to the illuminated resonant tag. In this fashion, an interrogator may build a three-dimensional image of the various resonant tag locations. In addition, the frequency shift based upon a pressure or temperature induced resonant frequency shift for the resonant tag enables the interrogator to know the temperature and/or pressure at the imaged tag locations.

In alternative embodiment, the interrogators may have no beam steering capabilities. Nevertheless, a roughly three-dimensional image of the resulting illuminated resonant tags may be determined from the beam widths for the interrogators. In other words, it would be assumed that received RF energy from an illuminated tag must have been from an illuminated tag within the beam width of the interrogator.

In alternative embodiments, the interrogator may be associated with an actuating device such as wire or cable that would enable an operator to “snake” the interrogator down the bore hole towards the casing perforations that enable the fracking fluid to escape into the hydrocarbon-bearing rock so as to hydraulically fracture this rock. For example, FIG. 7 illustrates a guide wire or cable 700 that may be used to position a pair of interrogators 705 so as to be adjacent a pair of opposing perforations in the well casing. These perforations are conventionally formed using a “perforating gun” that fires explosive shaped charges. The diameter of the perforation is typically from one half inch to approximately one inch in diameter. The interrogator antenna array is thus sized accordingly such that sufficient RF energy may be transmitted through the perforation towards the resonant tags within the propped fractures. After imaging through a given perforation, the guide wire may be actuated to move interrogator(s) 705 to a subsequent perforation.

One can well appreciate that a perforating gun forms many such perforations in the well casing. Thus, one need not image each and every perforation but instead sample them so as to adequately image the desired resonant tags.

### Active Tags

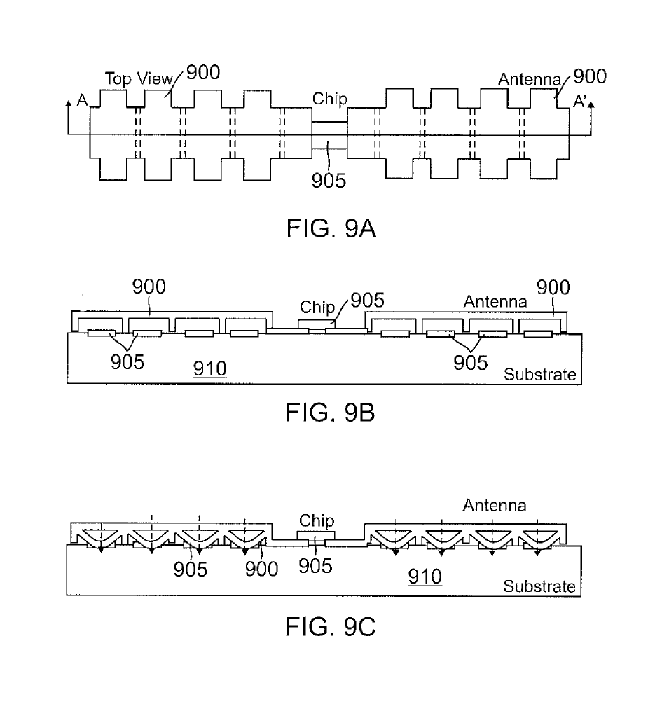

In alternative embodiments, the resonant tags discussed above may be modified to include active circuitry. This active circuitry may be passively powered as is known in the RFID arts or may instead scavenge energy such as through a piezoelectric transducer that can convert pressure and/or heat into electrical energy. The resulting active-circuitry-containing resonant tags may be denoted as resonant active tags. Although such active circuitry increases cost and complexity, a resonant tag may then be given an individual identity by modulating the resonant reflections with a digital code. Indeed, the transmissions from the interrogator may also be digitally modulated so as to target a particular resonant active tag or tags. A suspended beam resonant active tag embodiment will now be discussed. As seen in the top view of FIG. 9A, a concatenated series of suspended beams 900 form a meandering antenna that powers active circuitry 905. Beams 900 are formed analogously as discussed with regard to FIGS. 2A through 5B. Thus, as seen in the cross sectional view of FIG. 9B, each beam 900 is suspended above an electrode 905 on a semiconductor substrate 910. In this default (non-pressurized) state, beams 900 are not deflected towards substrate 910. But in response to pressure as seen in FIG. 9C, beams 900 deflect onto corresponding electrodes 905. Active circuitry 905 may be configured to respond to interrogation by modulating the resonant reflection from beams 900 with an identifying digital code. Alternatively, active circuitry 905 may modulate the resonant reflection with additional information such as temperature.

Note that each propped fracture acts as a waveguide. Thus, transmission and reflection within such a waveguide is virtually beamformed to follow the path of the propped fracture. Resonant active tags may be energized so as to communicate in an ad hoc manner within such a virtual waveguide and link to an interrogator so that the information from the various resonant active tags may be aggregated and eventually uploaded to a database either at the well site or remotely located through the Internet. Each response from an illuminated resonant active tag may be included with a header that identifies the illuminated resonant active tag so that a three-dimensional image may be developed of temperature and pressure within a given propped fracture. The real time data then is collected at the top of the well and connected to the Internet cloud. The gathered information is then decomposed and from information of the collective sensor cluster, forms the three dimensional map of the fractured well as well as ifs thermal gradient, pressure gradient, flow profile and health of link between sensors that is a sign of connectivity amongst the sensors inside the well.

The above specification, examples and data provide a complete description of the structure and use of exemplary embodiments of the invention as claimed below. Although various embodiments of the invention as claimed have been described above with a certain degree of particularity, or with reference to one or more individual embodiments, those skilled in the art could make numerous alterations to the disclosed embodiments without departing from the spirit or scope of this invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A resonant tag, comprising:
a substrate;
a beam suspended above the substrate by a pair of end walls; and
material configured to encapsulate the substrate, the beam, and the end walls such that the resonant tag has a size approximating the size of a proppant.

2. The resonant tag of claim 1, wherein the material comprises ceramic or resin.

3. The resonant tag of claim 1, wherein the beam and the pair of end walls comprises a gold layer.

4. The resonant tag of claim 1, wherein the substrate is a semiconductor substrate.

5. The resonant tag of claim 1, further comprising active circuitry configured to be powered by electrical energy received by the beam.

6. The resonant tag of claim 1, wherein the beam is configured to displace towards the substrate in response to application of pressure so as to change a resonant frequency for the beam.

7. The resonant tag of claim 1, further comprising an electrode positioned on the substrate to align with the beam.

8. A resonant tag, comprising:
a cylindrical array comprising a plurality of first cylinders arranged to form a second hollow cylinder;
a dielectric material configured to fill the second hollow cylinder; and
material configured to encapsulated the filled cylindrical array such that the resonant tag has a size approximating the size of a proppant.

9. The resonant tag of claim 8, wherein each first cylinder has a circular cross section.

10. The resonant tag of claim 9, wherein the second hollow cylinder has a radius of approximately 500 microns and wherein each first cylinder has a radius of approximately 20 microns.

11. The resonant tag of claim 8, wherein the cylindrical array comprises gold.

12. A method of interrogating a well, comprising:
mixing a plurality of resonant tags with proppants to form a hydraulic fracturing fluid, wherein each resonant tag comprises a substrate, a beam suspended above the substrate by a pair of end walls, and material configured to encapsulate the substrate, the beam, and the end walls such that the resonant tag has a size approximating the size of the proppants;
fracturing a rock layer surrounding the well with the hydraulic fracturing fluid to form propped fractures in the rock layer, wherein each propped fracture includes some of the resonant tags; and
interrogating the resonant tags in the propped fractures with a frequency modulated interrogating RF signal, wherein each beam is configured to have a resonant frequency that changes in response to pressure changes, and wherein the frequency modulation covers an expected range of the resonant frequencies induced by the pressure changes.

13. The method of claim 12, wherein the frequency modulation covers at least 20 MHz.

14. The method of claim 12, further comprising moving an interrogator down the well to be adjacent a first perforation, wherein the interrogation takes place through the first perforation.

15. The method of claim 14, further comprising moving the interrogator down the well to be adjacent a second perforation and interrogating through the second perforation.

16. A method, comprising
mixing a plurality of resonant tags with proppants to form a hydraulic fracturing fluid, wherein each resonant tag includes a cylindrical array comprising a plurality of first cylinders arranged to form a second hollow cylinder, a dielectric material configured to fill the second hollow cylinder, and material configured to encapsulated the filled cylindrical array such that the resonant tag has a size approximating the size of the proppants;
fracturing a rock layer surrounding the well with the hydraulic fracturing fluid to form propped fractures in the rock layer, wherein each propped fracture includes some of the resonant tags; and
interrogating the resonant tags in the propped fractures with a frequency modulated interrogating RF signal, wherein each second hollow cylinder is configured to have a resonant frequency that changes in response to temperature changes, and wherein the frequency modulation covers an expected range of the resonant frequencies induced by the temperature changes.

17. The method of claim 16, wherein the frequency modulation covers at least 20 MHz.

18. The method of claim 16, further comprising moving an interrogator down the well to be adjacent a first perforation, wherein the interrogation takes place through the first perforation.

19. The method of claim 18, further comprising moving the interrogator down the well to be adjacent a second perforation and interrogating through the second perforation.
